(19) United States
(12) Patent Application Publication
(10) Pub. No.: US 2009/0077491 A1
(43) Pub. Date: Mar. 19, 2009

(54) METHOD FOR INPUTTING USER COMMAND USING USER'S MOTION AND MULTIMEDIA APPARATUS THEREOF

(75) Inventor: Kyung-min KIM, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/051,074

(22) Filed: Mar. 19, 2008

(30) Foreign Application Priority Data
Sep. 17, 2007 (KR) 2007-94432

(51) Int. Cl. G06F 3/048

(52) U.S. Cl. 715/810; 715/764

(57) ABSTRACT

A method for controlling a multimedia apparatus includes determining whether a dragging function display command is input during a playback of content, if the dragging function display command is input, determining a type of the reproduced content, displaying a plurality of dragging functions according to the determined type of the content, and setting one of the plurality of dragging functions.

### CROSS-REFERENCE TO RELATED APPLICATION

This application claims the benefit of Korean Application No. 2007-94432, filed in the Korean Intellectual Property Office on Sep. 17, 2007, the disclosure of which is incorporated herein by reference.

### BACKGROUND OF THE INVENTION

1. Field of the Invention

Aspects of the present invention relate to a multimedia apparatus and a control method thereof, and more particularly, to a method for inputting a user command using a user's motion and a multimedia apparatus employing the same.

2. Description of the Related Art

Among digital audio apparatuses, an MP3 player stores content such as music and dialog in an embedded memory without using an extra tape or a compact disk (CD), and allows a user to select and enjoy the content when the user wishes to listen. The MP3 player provides a high quality sound equivalent to that of the CD in reproducing the stored information. Such an MP3 player displays a current operation state on a display panel so that the user can easily know the current operation state, and also displays diverse information about a currently reproduced MP3 audio on the display panel so that the user can easily know the information about the currently reproduced audio.

In recent years, in order to provide various amusements to the user, the MP3 player has been developed into a multimedia apparatus capable of reproducing multimedia content, such as an image and a broadcast signal, in addition to audio. Accordingly, various methods for inputting a user command into the multimedia apparatus providing various content have been demanded. One method is to add various keys to the multimedia apparatus to allow the user to input various user commands. However, this method increases the size of a multimedia apparatus and thus decreases portability. This method also negatively impacts the design of the multimedia apparatus.

In order to solve this problem, a recently developed multimedia apparatus employs a touch screen panel as a display; a user command can be input by a user's touch. However, this touch screen panel has to provide various display information corresponding to various user commands since a user command is input simply by touching the display information. Therefore, there is a problem in that the display information is likely to hide a part of a still image or a moving picture being reproduced.

### SUMMARY OF THE INVENTION

Aspects of the present invention provides a multimedia apparatus which is capable of setting a user's specific motion of a user as one of various user commands according to a type of content and reproducing a content according to the user's specific motion, and a controlling method thereof.

According to an aspect of the present invention, a method of controlling a multimedia apparatus is provided. The method includes determining whether a dragging function display command is input during a playback of content; if the dragging function display command is input, determining a type of the reproduced content; displaying a plurality of dragging functions according to the determined type of the content; and setting one of the plurality of displayed dragging functions.

According to another aspect of the present invention, the dragging is a user's motion that is made by touching an area where the content is displayed, and dragging from the touched area in a predetermined direction.

According to another aspect of the present invention, the determining of the type of the content comprises determining the type of content based on a compression type or file format of the content.

According to another aspect of the present invention, the content is at least one of a still image, a moving picture, a broadcast, text, or a combination thereof.

According to another aspect of the present invention, if the content is a moving picture, the displaying of the dragging functions comprises displaying at least one function of changing a reproduction speed, of reproducing a moving picture in the unit of file, and/or skipping forward a predetermined time.

According to another aspect of the present invention, the method further includes reproducing the content according to the set function, if a user command is input by dragging. If the content is a broadcast, the user command input by dragging is a user command to change a reproduced broadcast channel.

According to another aspect of the present invention, the dragging includes a normal-direction dragging and a reverse-direction dragging, and the reproducing of the content comprises reproducing a broadcast channel having a frequency higher than that of the reproduced broadcast channel, if the user command is input by the normal-direction dragging, and reproducing a broadcast channel having a frequency lower than that of the reproduced broadcast channel, if the user command is input by the reverse-direction dragging.

According to another aspect of the present invention, a multimedia apparatus is provided. The apparatus includes a display to display a dragging function, and a controller to list a plurality of dragging functions according to a type of the reproduced content if a command to display the dragging function is input during a playback of content and to display the list of dragging functions on the display. If a command to select one of the plurality of dragging functions is input, the controller sets the selected function to be a user command activated by a dragging.

According to another aspect of the present invention, the dragging is a user's motion that is made by touching an area of the display and dragging from the area in a predetermined direction.

According to another aspect of the present invention, the controller determines the type of the content based a compression type of the content.

According to another aspect of the present invention, if the content is a moving picture, the controller displays at least one function selectable between changing a reproduction speed, reproducing a moving picture in the unit of file, and skipping forward a predetermined time as the dragging function on the display.

According to another aspect of the present invention, if the content is a broadcast, the controller sets the detected dragging to be a user command to change a reproduced broadcast channel.

According to another aspect of the present invention, the dragging includes a normal-direction dragging and a reverse-direction dragging, and the controller sets the normal-direction dragging to be a user command to reproduce a broadcast channel having a frequency higher than that of the reproduced broadcast channel, and sets the reverse-direction dragging to be a user command to reproduce a broadcast channel having a frequency lower than that of the reproduced broadcast channel.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram illustrating an MP3 player which is a kind of digital multimedia apparatus according to an embodiment of the present invention;

FIG. 2 is a flowchart illustrating a process of setting a dragging, which is one of user's motions, as a specific user command according to an embodiment of the present invention;

FIGS. 3A to 3D are views illustrating a series of user interfaces (UIs) provided by an MP3 player in the process of setting a dragging as a specific user command according to an embodiment of the present invention;

FIGS. 4A and 4B are views illustrating operation of an MP3 player if content is a moving picture and if a dragging is set as a command to change a reproduction speed according to an embodiment of the present invention;

FIG. 5 is a view illustrating operation of an MP3 player if a user command is input by dragging for a radio broadcast which is being reproduced;

FIG. 6 is a view illustrating operation of an MP3 player if a dragging is performed for a still image which is being reproduced;

FIG. 7 is a view illustrating operation of an MP3 player if a dragging is performed for a text which is being reproduced; and

FIG. 8 is a view illustrating operation of an MP3 player if a dragging is performed for a music which is being reproduced.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

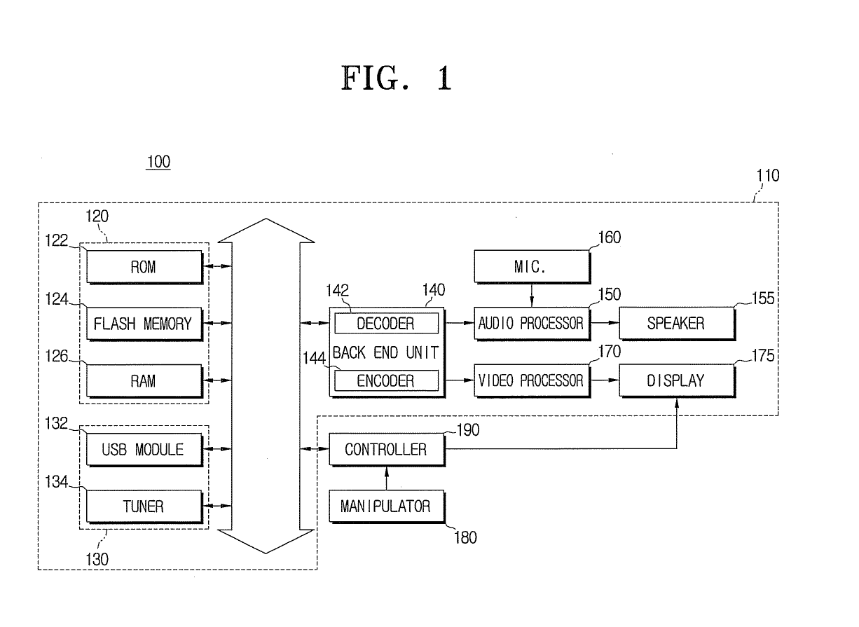

FIG. 1 shows an MP3 player 100, which is an example of a digital multimedia apparatus, according to an embodiment of the present invention. The MP3 player 100 includes a storage unit 120, a communication interface 130, a back end unit 140, an audio processor 150, a speaker 155, a microphone 160, a video processor 170, a display 175, a manipulator 180, and a controller 190. According to other aspects of the present invention, the MP3 player 100 may include additional and/or different units. Similarly, the functionality of one or more of the above units may be integrated into a single component.

The storage unit 120 stores program information, contents, content information, and icon information that may be required to control the MP3 player 100, and includes a read only memory (ROM) 122, a flash memory 124, and a random access memory (RAM) 126. The content may be compressed using a compression technique such as MP3, AAC, JPEG, GIF, and the like, and may also be stored in an uncompressed format.

The ROM 122 stores information which has to be retained even in a power-off state, such as contents of the MP3 player (songs, pictures, and the like), content information, menu information, icon information, program information relating to an icon, and various user command information defined by a user. According to aspects of the present invention, the user can set a user's motion as a specific user command stored in the ROM 122. The flash memory 124 stores a program to control the back end unit 140 and various data for retention purpose, which can be updated. The RAM 126 is a storage space in which various backup data is temporarily stored, and serves as a working memory for the controller 190. The data stored in the ROM 122 and the flash memory 124 still remain even in a power-off state, whereas the data stored in the RAM 126 is deleted in a power-off state. While described as separate memories, the ROM 122, RAM 126, and/or the flash memory 124 may be combined and/or replaced with other volatile or non-volatile memories.

The communication interface 130 performs data communication between an external device (not shown) and the MP3 player 100. Although not required in all aspects, as shown in FIG. 1, the MP3 player 100 includes a USB module 132 and a tuner 134. The USB module 132 transmits and receives data input and output to and from a USB device, such as a PC, and a USB memory. The tuner 134 receives a radio or a television broadcast and transmits the broadcast to the back end unit 140. According to aspects of the present invention, content comprises a still image file, a moving picture file, an audio file and/or a broadcast. The content may also include other types of digital multimedia. The communication interface 130 may include other interfaces, such as wireless interfaces, in addition to, or instead of, the USB module 132 and/or the tuner 134.

The back end unit 140 is an element that is responsible for a signal-processing such as compression, decompression, and reproduction with respect to video and/or audio. The back end unit 140 comprises a decoder 142 and an encoder 144. According to other aspects of the invention, the back end unit 140 may contain just the decoder 142 or just the encoder 144.

The decoder 142 decompresses a file output from the storage unit 120 or data output from the communication interface 130, applies decompressed audio to the audio processor 150, and applies decompressed video to the video processor 170. The encoder 144 compresses video and audio input from the communication interface 130 in a predetermined format, and transmits the compressed file to the storage unit 120. The encoder 144 may compress audio input from the audio processor 150 in a predetermined format and transmit the compressed audio to the storage unit 120, and/or transcode from one format to the predetermined format.

The audio processor 150 converts an analog audio signal input through an audio input element, such as the microphone 160 into a digital audio signal, and transmits the converted signal to the back end unit 140. The audio processor 150 may convert a digital audio signal output from the back end unit 140 into an analog audio signal and output the converted signal through the speaker 155. However, the audio input element and the encoder 144 need not be employed in all aspects.

The video processor 170 is an element that performs a signal-processing with respect to an image input from the back end unit 140 and outputs the image to the display 175. The display 175 is a display element that displays an image, a text, and an icon output from the video processor 170 or the controller 190.

The manipulator 180 receives a user's manipulation command and transmits it to the controller 190. The manipulator 180, as shown in FIG. 1, is divided into an integral type and a split type with respect to the MP3 player 100, though the manipulator is not limited thereto. The manipulator 180 may be embodied as a user interface (UI) allowing a user to input a user command through a menu display displayed on the display 175. In this embodiment, the MP3 player 100 provides a touch screen panel that incorporates functions of the display 175 and the manipulator 180. Accordingly, the user inputs a user command by touching an area where information is displayed, while viewing the information displayed on the touch screen panel. According to other aspects of the invention, the manipulator 180 may be separate from the display 175 or may be incorporated into a separate display.

The controller 190 controls entire operations of the MP3 player 100. The controller 190 controls the respective function blocks 110 of the MP3 player according to a user's command input through the manipulator 180. For example, if a user inputs a command to reproduce a file stored in the storage unit 120, the controller 190 controls various units of a function block 110. A file is read out from the storage unit 120 and is applied to the back end unit 140. The back end unit 140 decodes the file, and the audio processor 150 and the video processor 170 signal-process audio and video respectively. The audio is output through the speaker 155 and the video is output through the display 175.

If a command to display a menu for reproduced content is input, the controller 190 generates a menu relating to the reproduced content and displays the menu on the display 175. The menu may comprise an item for which a user command can be set by the user.

One user motion that can be set as a user command is dragging. Dragging is a user's motion that is made by touching a predetermined point on the touch screen panel with a user's finger, and dragging from the point to a predetermined distance. The dragging is divided into a normal-direction dragging in which the user horizontally drags from the right to the left and a reverse-direction dragging in which the user horizontally drags from the left to the right. These types of dragging are referred to as horizontal dragging. Dragging, as defined herein, is one example of the user's motions. Other user motions may be employed according to other aspects of the present invention, such as touching the touch screen channel, touching and dragging with two or more fingers, motions in other directions, and non-linear motions.

The user can set the dragging as one of various user commands. For example, if content is a moving picture, the user can set the dragging as a command to change a reproduction speed of a moving picture, a command to produce a moving picture in the unit of file, or a command to skip forward a predetermined time.

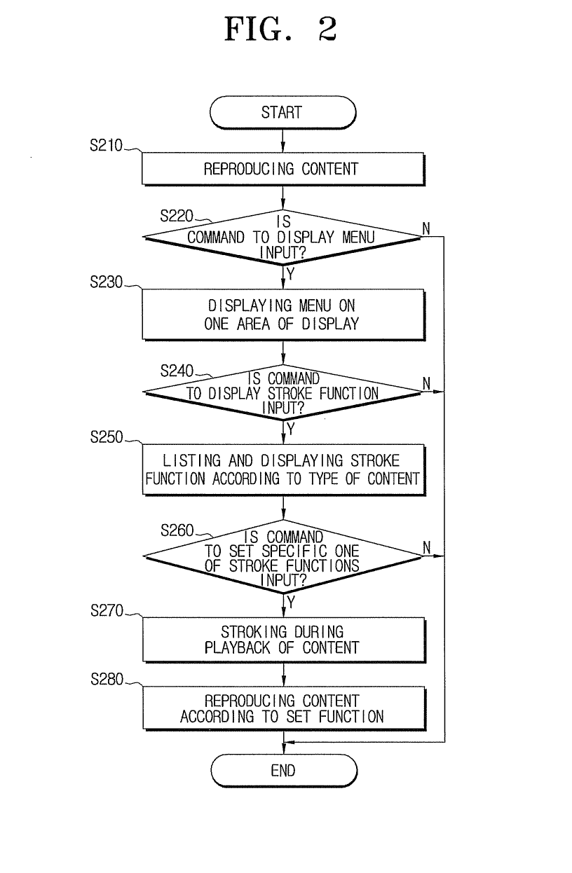

FIG. 2 is a flowchart of a process for setting a dragging as a specific user command according to an embodiment of the present invention. The controller 190 determines whether a command to display a menu is input in operation S220, while the MP3 player 100 reproduces specific content in operation S210. If the MP3 player 100 has a touch screen panel, the user touches the touch screen panel. The touch screen panel displays ‘Menu’ display information on an area thereof, and the user inputs the command to display the menu by touching the ‘Menu’ display information.

If the command to display the menu is input, the controller 190 displays the menu on the area of the display 175 in operation S230. The controller 190 reads out content information about currently reproduced content from the ROM 122, generates the menu based on the content information, and controls the display 175 to display the generated menu on a predetermined area of the display 175 in a pop-up window form. The menu may include a ‘dragging’ item. The controller 190 determines whether a command to display a dragging function is input in operation S240.

The user inputs the command to display the dragging/stroking function by touching the item ‘dragging’ on the menu. The controller 190 lists the dragging functions according to a type of currently reproduced content and displays the list on the display 175 in operation S250. The user command that can be input by the dragging may differ depending on the type of content. For example, if currently reproduced content is a moving picture, the user command that can be input by the dragging may be a command to reproduce content in the unit of file, a command to change a reproduction speed, or a command to skip forward a predetermined time. If currently reproduced content is a still image, the user command that can be input by the dragging may be a command to reproduce a still image in the unit of frame or a command to reproduce a still image in the unit of file. The user command that can be input by the dragging may be already defined according to the type of content in the process of manufacturing the MP3 player 100; the user may set the dragging as a specific user command through the ‘dragging’ item.

In determining the type of content, the controller 190 considers a compression format or file format of the current reproduced content. For example, the controller 190 may determine that the content is a moving picture if the content is compressed in an MPEG format, and may determine that the content is a still image if the content is compressed in a JPEG format. If the content is not compressed, the controller 190 may determine that the content is text. According to other aspects of the invention, the controller 190 may determine the content type based on a file format of the content type, such as AVI, JPEG, DOC, or TXT. Whether a content received through the tuner 134 is a broadcast signal may also be determined.

The controller 190 determines whether a command to select a specific one of the listed dragging functions is input in operation S260. The user selects a specific function from the list of dragging functions displayed on the area of the display 175 in the pop-up window form to set as a user command.

If the user performs a dragging in the process of reproducing the content in operation S270, the MP3 player 100 recognizes the dragging as a specific user command and reproduces the content in response to the specific user command in operation S280.

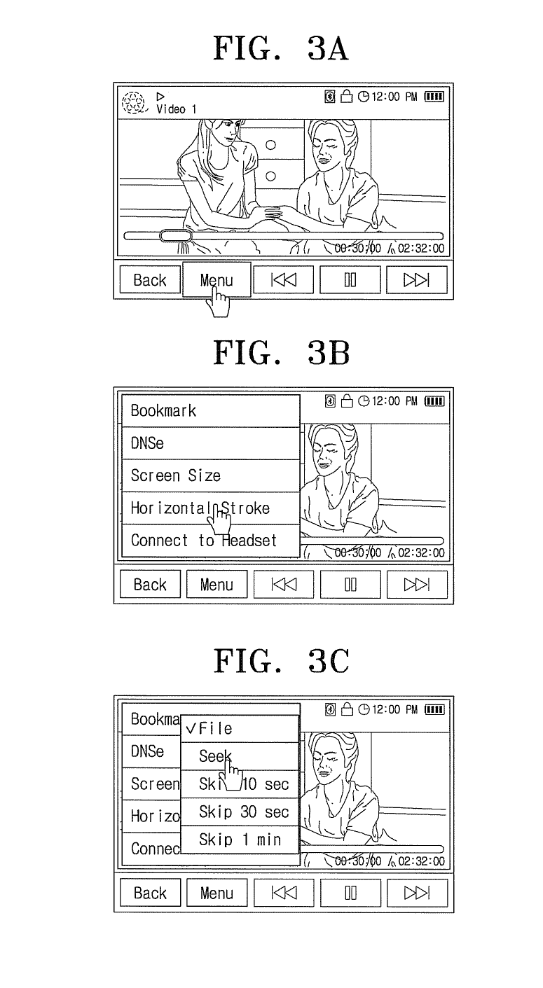

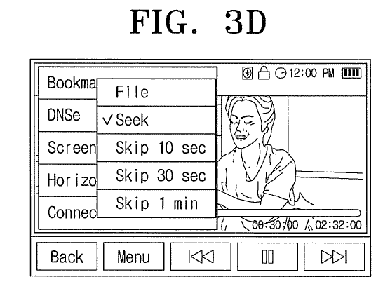

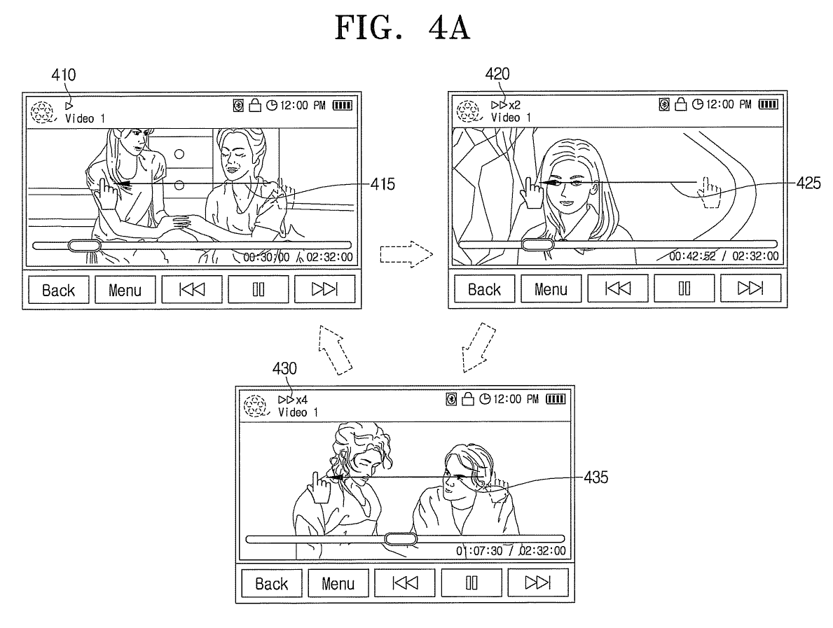

FIGS. 3A to 3D show a series of UIs provided by the MP3 player 100 in the process of setting a dragging as a specific user command according to an exemplary embodiment of the present invention. As shown in FIG. 3A, the user touches an area on which the ‘Menu’ display information is displayed while a moving picture is being reproduced, thereby selecting the ‘Menu’ display information.

If the user selects the ‘Menu’ display information, the controller 190 generates a menu including a ‘dragging’ item and displays the menu on an area of the display 175 in a pop-up window form as shown in FIG. 3B. The user touches an area on which the ‘dragging’ item is displayed, thereby inputting a command to display a dragging function. If the content is a moving picture, as shown in FIG. 3C, the controller 190 generates a list of functions that can be input by dragging as a user command, and displays the list on an area of the display 175.

If content is a moving picture, the function that can be input by dragging as a user command includes a ‘File’ item which is a command to reproduce a moving picture in the unit of file, a ‘Seek’ item which is a command to change a reproduction speed, a ‘Skip 10 sec’ item which is a command to skip forward 10 seconds on a currently reproduced moving picture, a ‘Skip 30 sec’ item which is a command to skip forward 30 seconds, and a ‘Skip 1 min’ item which is a command to skip forward 1 minute. FIG. 3C shows that dragging is set as a command to reproduce a moving picture in the unit of file.

If a user wishes to set a dragging as a command to change a reproduction speed, the user touches an area on which the ‘Seek’ item is displayed. Then, a check mark (or other indicator) indicating that a dragging is used as a command to change a reproduction speed is displayed as shown in FIG. 3D.

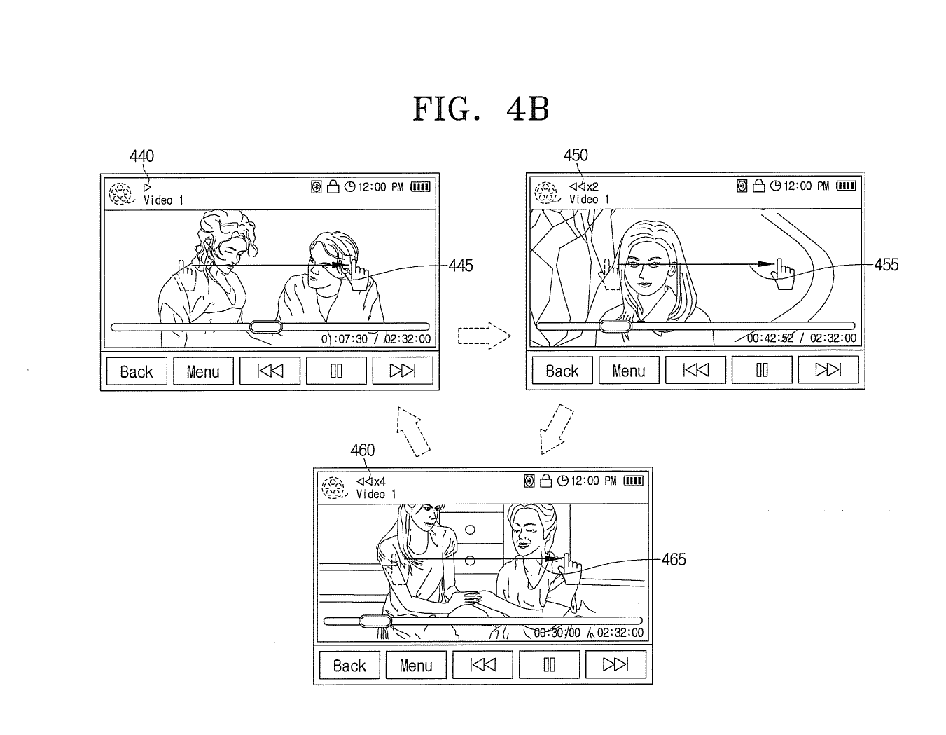

FIGS. 4A and 4B show operation of the MP3 player 100 if content is a moving picture and if dragging is used as a command to change a reproduction speed. As shown in FIG. 4A, if a user performs a first normal-direction dragging 415 on an area of the display 175 during a playback of a moving picture, the MP3 player 100 reproduces the moving picture at 2 times the normal speed 420. Then, if the user performs a second normal-direction dragging 425 on an area of the display 175, the MP3 player 100 reproduces the moving picture at 4 times the normal speed 430. If the user performs a third normal-direction dragging 435 while the moving picture is played at 4 times the normal speed, the MP3 player 100 returns to the original speed and reproduces the moving picture at the normal speed 410.

If the user performs a first reverse-direction dragging 445 on an area of the display 175 during a playback of a moving picture as shown in FIG. 4B, the MP3 player 100 rewinds the moving picture at 2 times the normal speed 450. If a second reverse-direction dragging 455 is further performed, the MP3 player 100 rewinds the moving picture at 4 times the normal speed 460. If the user performs a third reverse-direction dragging 465 while the moving picture is rewound at 4 times the normal speed, the MP3 player 100 returns to the normal speed 440.

In FIGS. 4A and 4B, the dragging is set as a command to change a reproduction speed. However, a dragging may be set as a command to play in the unit of file or a command to skip forward a predetermined time. If a dragging is set as a command to play in the unit of file and if the user performs a normal-direction dragging during a playback of a moving picture, a next file of a currently reproduced moving picture is reproduced, and if a reverse-direction dragging is performed, a previous file of the currently reproduced moving picture is reproduced. Since the user can freely set one user's motion as one of several commands, the user can change the manipulation of the multimedia apparatus conveniently.

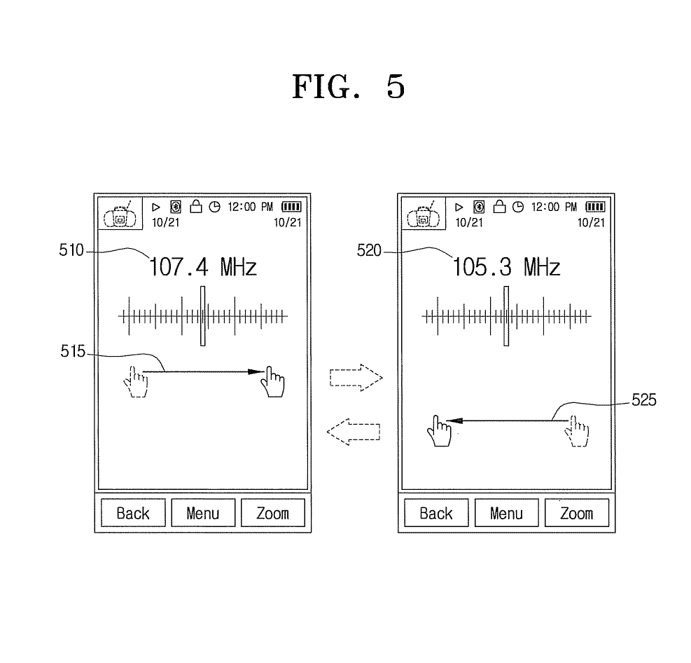

FIG. 5 shows operation of the MP3 player 100 if a user inputs a user command by dragging while listening to a radio broadcast. As shown in FIG. 5, if a user performs a reverse-direction dragging 515 on an area of the display 175 while listening to a radio broadcast of 107.4 MHz channel, the controller 190 determines a type of currently reproduced content. If the currently reproduced content is a radio broadcast received through the tuner 134, the controller 190 determines a dragging input by the user as a command to change a channel. The controller 190 recognizes the dragging as a command to change to a channel having a frequency lower than that of a current channel.

The controller 190 generates a control signal to search for a channel having a frequency lower than that of the current channel received by the tuner 134, and transmits the control signal to the tuner 134. The tuner 134 scans broadcast channels having a lower frequency than that of the current channel, and receives a broadcast of the firstly tuned 105.3 MHz channel 520 and applies the broadcast to the back end unit 140. The back end unit 140 decompresses the radio broadcast signal (if necessary) and the audio processor 150 signal-processes the radio broadcast and outputs the broadcast through the speaker 155. If the user performs a normal-direction dragging 525 while listening to the 105.3 MHz channel broadcast, the MP3 player scans frequencies higher than 105.3 MHz, receives the firstly tuned 107.4 MHz broadcast channel 510 and plays the broadcast channel 510. A similar process may be employed for a video broadcast.

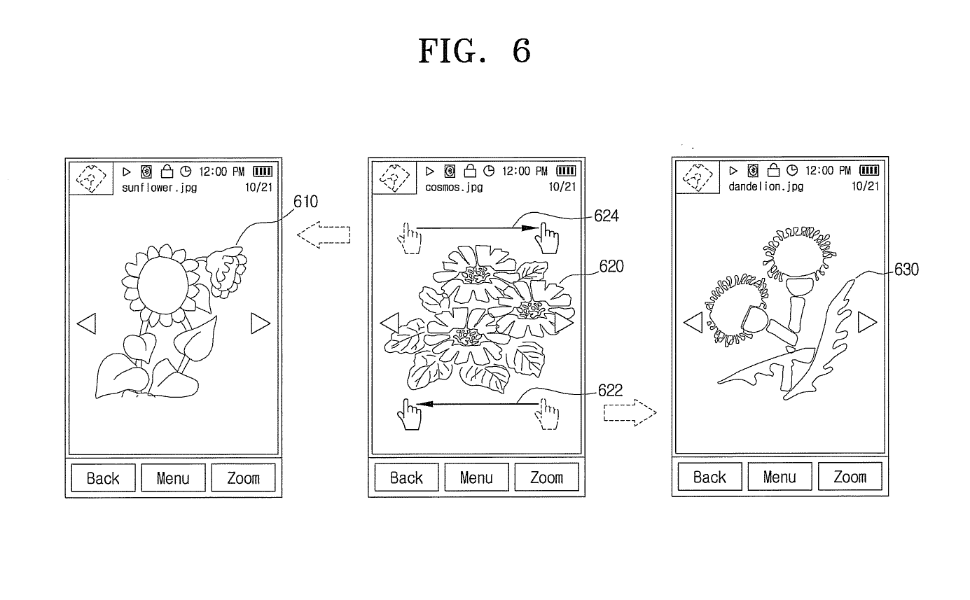

FIG. 6 shows operation of the MP3 player 100 if a dragging is performed during a playback of a still image. If the user performs a normal-direction dragging 622 on a displayed second still image 620, the controller 190 controls the respective function blocks 110 to display a third still image next to the second still image 620 on the display 175, and the display 175 displays the next third still image 630. If the user performs a reverse-direction dragging 624 on the second still image 620, the controller 190 controls the display 175 to display a previous first still image 610 of the second still image 620. If still images are arranged in an album, the user can view the still images by turning pages of the album. The user may view the next images by performing a normal-direction dragging and enjoys the previous images by performing a reverse-direction dragging, and also feels amusement as he makes motions.

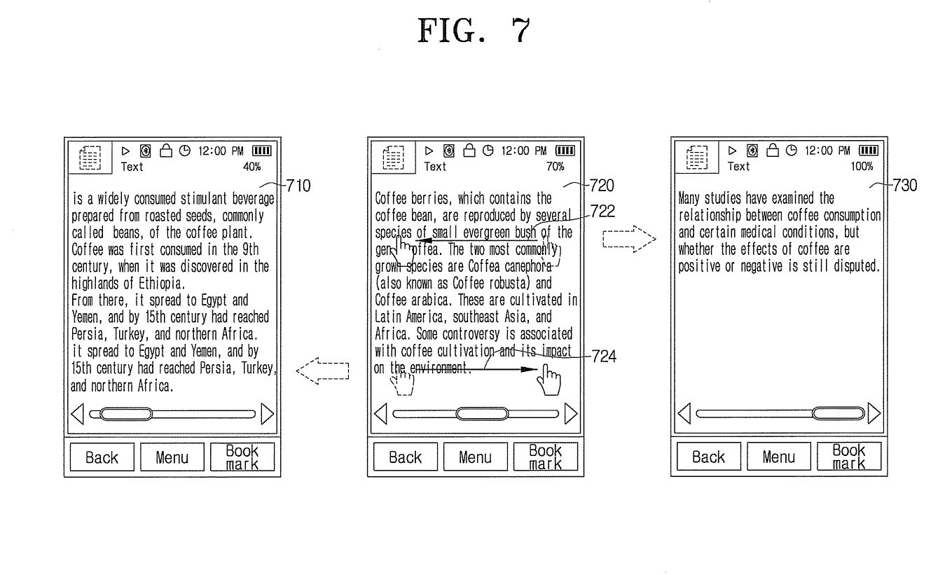

FIG. 7 shows operation of the MP3 player 100 if a dragging is performed during reproduction of text. Text is reproduced and displayed differently than a still image, but a user command by dragging has the same effect as the still image. Therefore, if the user performs a normal-direction dragging 722 on a current page 720, the display 175 displays a next page 730, and if the user performs a reverse-direction dragging 724 on the current page 720, the display 175 displays a previous page 710. The user feels as if he/she is turning pages of a book.

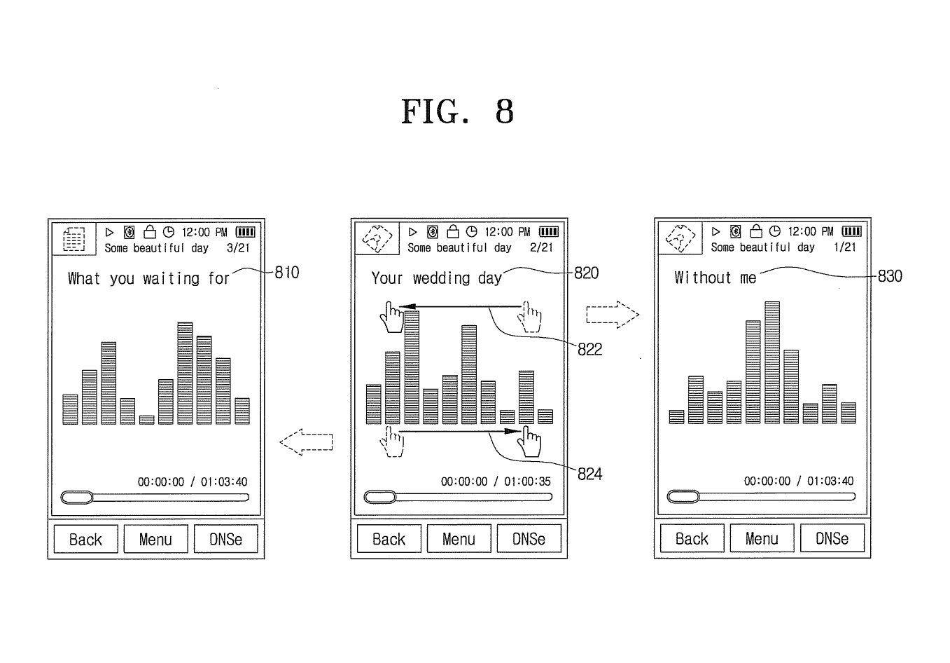

FIG. 8 shows operation of the MP3 player 100 if a dragging is performed during a playback of music. The user may perform a normal-direction dragging 822 on the display 175 during a playback of the music ‘Your wedding day’ 820. Then, the MP3 player reproduces the next music ‘Without me’ 830. If the user performs a reverse-direction dragging 824 on the display 175 during the playback of the music ‘Your wedding day’ 820, the MP3 player 100 reproduces the previous music ‘What you waiting for’ 810.

If content is a still image, a text or music, the above description about the user command by the dragging is merely an example. Like a moving picture, the dragging for the above content such as still image, text and music can be set for any one of several functions.

The above description was made with reference to dragging, which is one of the user's various motions, but this should not be considered as limiting. In addition to the horizontal dragging, a vertical dragging or a trace of touch can be defined as a user command.

As described above, the MP3 player 100 was described as an example of the multimedia apparatus, but aspects of the present invention are not limited thereto. Aspects of the present invention are applicable to any electronic apparatus that can reproduce content and provide a touch screen, such as a mobile phone, a personal digital assistant (PDA), a personal entertainment device, and an audio system.

As described above, according to the aspects of the present invention, the user may set a user's specific motion as a specific function for the multimedia apparatus and thus can freely change a manipulation command of the multimedia apparatus.

Since a user's specific motion of the user is input as a user command, an amusement factor is added in manipulating the multimedia apparatus. In addition, since the user can input diverse user commands for different content by performing a single motion, a user's satisfaction for the multimedia apparatus can be improved.

Aspects of the present invention can also be embodied as computer readable codes on a computer readable recording medium. The computer readable recording medium is any data storage device that can store data which can be thereafter read by a computer system. Examples of the computer readable recording medium also include read-only memory (ROM), random-access memory (RAM), CDs, DVDs, Blu-ray discs, magnetic tapes, floppy disks, and optical data storage devices. The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

Although a few embodiments of the present invention have been shown and described, it would be appreciated by those skilled in the art that changes may be made in this embodiment without departing from the principles and spirit of the invention, the scope of which is defined in the claims and their equivalents.

1. A method of controlling a multimedia apparatus, the method comprising:
determining a type of a reproduced content;
displaying a plurality of dragging functions according to the determined type of the content; and
setting one of the plurality of displayed dragging functions.

2. The method according to claim 1, wherein the dragging is a user's motion that is made by touching an area where the content is displayed, and dragging from the touched area in a predetermined direction.

3. The method according to claim 1, wherein the determining of the type of the content comprises determining the type of content based on a compression type or file format of the content.

4. The method according to claim 1, wherein the content is at least one of a still image, a moving picture, a broadcast, text, or a combination thereof.

5. The method according to claim 1, wherein, if the content is a moving picture, the displaying of the dragging functions comprises displaying at least one function of changing a reproduction speed, of reproducing a moving picture in the unit of file, and/or skipping forward a predetermined time.

6. The method according to claim 4, further comprising:
reproducing the content according to the set function, if a user command is input by dragging;
wherein, if the content is a broadcast, the user command input by dragging is a user command to change a reproduced broadcast channel.

7. The method according to claim 6, wherein:
the dragging comprises a normal-direction dragging and a reverse-direction dragging; and
the reproducing of the content comprises reproducing a broadcast channel having a frequency higher than that of the reproduced broadcast channel, if the user command is input by the normal-direction dragging, and reproducing a broadcast channel having a frequency lower than that of the reproduced broadcast channel, if the user command is input by the reverse-direction dragging.

8. A multimedia apparatus comprising:
a display to display a plurality of dragging functions according to a type of a reproduced content; and
a controller to set a function selected among the plurality of dragging functions to be a user command activated by dragging.

9. The multimedia apparatus according to claim 8, wherein the dragging is a user's motion that is made by touching an area of the display and dragging from the area in a predetermined direction.

10. The multimedia apparatus according to claim 8, wherein the controller determines the type of the content based a compression type or file format of the content.

11. The multimedia apparatus according to claim 8, wherein the content is at least one of a still image, a moving picture, a broadcast, text, or a combination thereof.

12. The multimedia apparatus according to claim 11, wherein, if the content is a moving picture, the controller displays at least one function selectable between changing a reproduction speed, reproducing a moving picture in the unit of file, and skipping forward a predetermined time based on the dragging function on the display.

13. The multimedia apparatus according to claim 11, wherein, if the content is a broadcast, the controller sets the detected dragging to be a user command to change a reproduced broadcast channel.

14. The multimedia apparatus according to claim 13, wherein:
the dragging comprises a normal-direction dragging and a reverse-direction dragging; and
the controller sets the normal-direction dragging to be a user command to reproduce a broadcast channel having a frequency higher than that of the reproduced broadcast channel, and sets the reverse-direction dragging to be a user command to reproduce a broadcast channel having a frequency lower than that of the reproduced broadcast channel.

15. A method of controlling a multimedia apparatus having a touch screen, comprising:
assigning a command to a user motion, based on input received from a user;
receiving user input corresponding to the user motion during reproduction of content on the multimedia apparatus; and
performing the assigned command in response to the user input.

16. The method of claim 15, wherein the user motion is a dragging motion comprising touching the touch screen and dragging for a predetermined distance.

17. The method of claim 15, wherein the performing of the assigned command comprises:
determining a type of the content being reproduced; and
performing the assigned command based on the type of the content.

18. The method of claim 15, wherein the assigning of the command comprises:
selecting one of a plurality of user motions; and
for the selected motion, selecting one of a plurality of commands corresponding to a type of the content.

19. A computer readable medium comprising instructions that, when executed by a multimedia apparatus, cause the multimedia apparatus to perform the method of claim 15.

20. A multimedia apparatus comprising:
a touchscreen to display content and to receive user input; and
a controller to assign a command to a user motion based on input from a user and to perform the assigned command in response to the user motion on the touchscreen.

21. The multimedia apparatus of claim 18, wherein the user motion is a dragging motion comprising touching the touch screen and dragging for a predetermined distance.

22. The multimedia apparatus of claim 18, wherein the controller determines a type of content being reproduced by the multimedia apparatus and performs the assigned command based on the type of the content.
